(19) United States
(12) Patent Application Publication
(10) Pub. No.: US 2004/0245789 A1
(43) Pub. Date: Dec. 9, 2004

(54) Cover handling tool

(76) Inventors: Seth J. Berl, Loudonville, NY (US); Leonard S. Berl, Loudonville, NY (US); Thomas Schrader, Albany, NY (US)

Correspondence Address: HOFFMAN WARNICK & D'ALESSANDRO, LLC, 3 E-COMM SQUARE, ALBANY, NY, 12207

(21) Appl. No.: 10/438,948

(22) Filed: May 15, 2003

(51) Int. Cl. B65G 7/12; B65G 9/00

(52) U.S. Cl. 294/15

(57) ABSTRACT

A cover handling tool is provided that includes a handle, an elongate portion extending from the handle, and an engagement portion extending from the elongate portion. The engagement portion includes a notch for engaging, removing and relocating the cover. The tool can also include other features such as one or more apertures for attaching a testing tool, a rotatable handle, an adjustable elongate portion and a support member. In use, the engagement portion will be passed through an opening in the cover. The notch within the engagement portion will engage a lip that is adjacent the opening. Then, by lifting directly upwards, the cover can be freed from the skimmer.

### BACKGROUND OF THE INVENTION

1. Field of the Invention

The present invention generally relates to a cover handling tool. Specifically, the present invention provides a tool that engages an aquatic cover for easy removal.

2. Related Art

Pools, spas and the like are becoming increasingly popular in modern society. For example, today, many homeowners are installing such aquatic devices for recreation, medical treatment, etc. Each of these aquatic devices commonly requires a filtration device so that the water can be maintained according to acceptable standards. Slight variations in temperature, pH, chlorine level can not only affect the users' enjoyment, but their safety as well. As is well know, each aquatic device includes one or more “skimmers” to which the filtration device is connected. In general, the filtration device provides suction that draws the water from the aquatic device into the skimmers. Each skimmer typically includes a porous basket that captures foreign objects such as leaves. After the water passes through the porous basket, it is the processed by the filter and then returned to the aquatic device through one or more ports.

Proper maintenance of an aquatic device requires regular emptying of the baskets within the skimmers. If this is not properly done, the basket can become clogged which will prevent the water from being treated by the filtration device. In the case of in ground pools and spas, the skimmers are often positioned around the edge thereof within the concrete. To this extent, the skimmers are positioned such that their covers rest flush with the top surface of the concrete. Unfortunately, although this design may be aesthetically pleasing, it is not always the most functional. Specifically, due to the heat of the concrete and/or the weight of people walking over them, the covers often become lodged within the skimmer. When this happens, a great amount of force is required to free the cover from the skimmer. Such force can not only cause damage to the cover, but it could also result in severe injury to the user.

In view of the foregoing, there exists a need for a cover handling tool. Specifically, a need exists for a tool that can engage and allow safe and easy removal of an aquatic filter cover.

### SUMMARY OF THE INVENTION

In general, the current invention provides a cover handling tool. Specifically, the tool of the present invention includes a handle, an elongate portion extending from the handle, and an engagement portion extending from the elongate portion. The engagement portion includes a notch for engaging, removing and relocating the cover. The tool can also include other features such as one or more apertures for attaching a testing tool, a rotatable handle, an adjustable elongate portion and a support member. In use, the engagement portion will pass through an opening in the cover. The notch within the engagement portion will engage a lip that is adjacent the opening. Then, by lifting directly upwards, the cover can be freed from the skimmer.

A first aspect of the invention provides a tool for handling a cover, the tool comprising: a handle; an elongate portion extending from the handle; and an engagement portion extending from the elongate portion, wherein the engagement portion includes a notch for engaging the cover.

A second aspect of the invention provides a tool for handling a cover, the tool comprising: a handle; a grip rotatably attached to the handle; an elongate portion extending from the handle at a first end of the elongate portion; and a engagement portion extending from the elongate portion at an opposing second end of the elongate portion.

A third aspect of the invention provides a tool for handling a cover, the tool comprising: a handle; a grip rotatably attached to the handle; an elongate portion extending from the handle at a first end of the elongate portion; a engagement portion extending from the elongate portion at an opposing second end of the elongate portion, wherein the engagement portion includes a notch for engaging the cover; and an aperture on at least one of the engagement portion and the elongate portion for temporarily attaching a testing tool.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative aquatic filter cover to be removed with a tool according to the present invention.

FIG. 2 depicts a tool for removing the cover of FIG. 1, according to the present invention.

FIG. 3 depicts the cover of FIG. 1 being removed by the tool of FIG. 2, according to the present invention.

FIG. 4 depicts the tool of FIG. 2 having at least one testing aperture, according to another aspect of the present invention.

FIG. 5 depicts the tool of FIG. 2 having a rotatable handle and an adjustable elongate portion, according to another aspect of the present invention.

FIG. 6 depicts the tool of FIG. 2 having a support member, according to yet another aspect of the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the current invention provides a cover handling tool. Specifically, the tool of the present invention includes a handle, an elongate portion extending from the handle, and an engagement portion extending from the elongate portion. The engagement portion includes a notch for engaging, removing and relocating the cover. The tool can also include other features such as one or more apertures for attaching a testing tool, a rotatable handle, an adjustable elongate portion and a support member. In use, the engagement portion will pass through an opening in the cover. The notch within the engagement portion will engage a lip that is adjacent the opening. Then, by lifting directly upwards, the cover can be freed from the skimmer

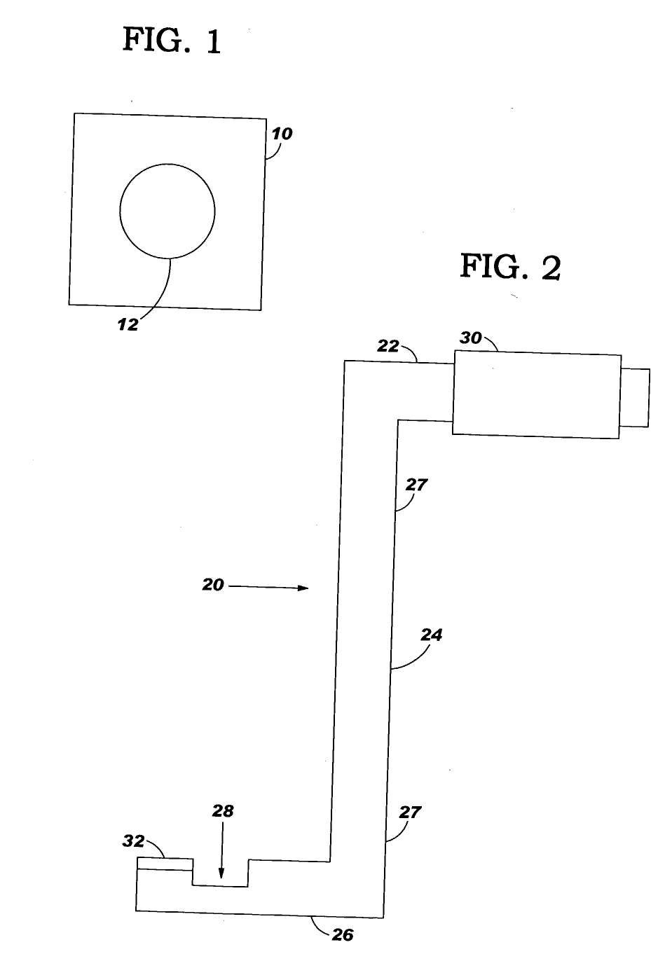

Referring now to FIGS. 1-2, an illustrative cover 10 and tool 20 are shown. As depicted, tool 20 includes elongate portion 24, handle 22 extending from a first end 25 of elongate portion 24, and (cover) engagement portion 26 extending from a second end 27 of elongate portion 24. Notch 28 is positioned within engagement portion 26 for engaging cover 10 for removal thereof from a skimmer or the like. Specifically, as will be further depicted below, engagement portion 26 passes through opening 12 in cover 10 and engages a lip that is adjacent to opening 10. Once engaged, tool 20 is lifted upwards to free cover 10 from a skimmer.

As further shown in FIG. 2, tool can also optionally include grip 30 and/or testing tool 32. If provided, grip 30 can be rotatable to allow tool 20 to be “swung” side to side within the water. Specifically, a user can hold grip 30 and insert at least the engagement portion 26 of tool 20 into the water (e.g., from outside of the pool) so that testing tool 32 is submersed. Once submersed, tool 20 can be swung side to side via rotatable grip 30 so that testing tool 32 makes ample contact with the water. Testing tool 32 can include any type of device/material that is used to test water. For example testing tool 32 can measure the temperature, pH, and/or chlorine (or other chemical) level of the water.

In general, tool 20 is formed from a rigid material such as metal (e.g., steel, iron, aluminum, etc.) or plastic (e.g., PVC). In addition, tool 20 can have any dimensions and/or angles that would facilitate the removal of cover 10. To this extent, elongate portion 24 should be sufficient length so that a user can remove cover 10 from a substantially upright position. Suitable lengths of elongate portion 24 range from approximately 18 to approximately 48 inches. Moreover, engagement portion 26 should have a length that would allow it to be inserted through opening 12 and remove cover 10. For example, engagement portion 26 can be anywhere from approximately 1 to approximately 4 inches in length. Handle 22 need only have enough length and/or width to provide a user with a comfortable grip. For example, handle 22 should be anywhere from approximately 3 to approximately 6 inches in length. As further shown, tool 20 is constructed so that engagement portion 26 and handle 22 are perpendicular to elongate portion 24. That is, handle 22 and engagement portion 26 are at approximately 90 degree angles with respect to elongate portion 24. However, this need not be the case. For example, engagement portion 26 could be at a 45 degree angle with respect to elongate portion 24, while handle 22 could be at a 135 degree angle with respect to elongate portion 24. To this extent, it should be appreciated that any arrangement of angles could be provided.

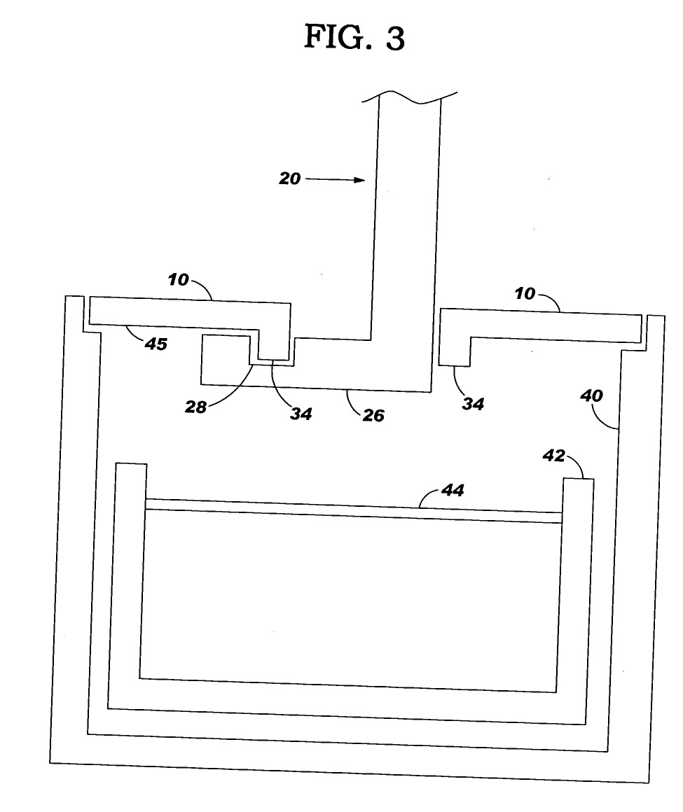

Referring now to FIG. 3, use of tool 20 to remove cover 10 from skimmer 40 is shown in greater detail. As depicted, cover 10 typically includes a lip 28 that is adjacent opening 12. In general, lip 34 is provided around the periphery of opening 12. To remove cover 12 from skimmer 40, engagement portion 26 will be inserted through opening 12 and positioned so that notch 28 engages lip 34. Once in position, tool 20 is lifted upwards to remove cover 10 from skimmer 40. In a typical embodiment, tool 20 is lifted directly upwards so that cover 10 is pulled in a straight, vertical direction. This will avoid damage to cover 10 that could result when cover 10 is removed at an angle. In any event, once cover 12 is removed, basket 42 can be removed via handle 44 and emptied.

It should be appreciated that the embodiment of cover 10 and skimmer 40 shown in FIG. 3 is for illustrative purposes only and that other variations could exist. For example, it could be the case that cover 10 is provided without lip 34. In this case, engagement portion 26 could engage underside 45 of cover 10 itself. In addition, although notch 28 is shown having a “squared shape,” other variations could be provided. For example, notch 28 could be “v-shaped.” Still yet, although cover 10 is depicted as being a cover for skimmer 40, this need not be the case. Rather, tool 20 can be used to remove any type of cover.

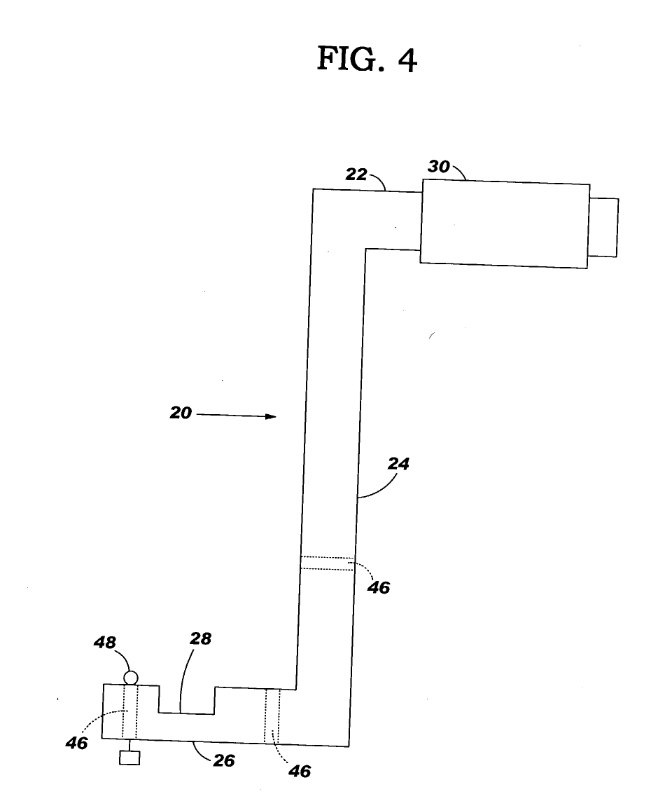

Referring now to FIG. 4, it is shown that tool 20 can include one or more testing apertures 46 for attaching testing tool 48. If provided, such apertures 46 can be positioned on elongate portion 24, and/or engagement portion 26 on any side of notch 28. Similar to testing tool 32 of FIG. 2, testing tool 48 can be removably attached to apertures to test properties of the water. To this extent, testing tool 28 can include any device/material that would allow a user to measure the temperature, pH, chlorine (or other chemical) level, etc. of the water. In addition, if one or more apertures 46 are provided, rotatable grip 30 could also be provided so that tool 20 can be moved (swung) side to side in the water.

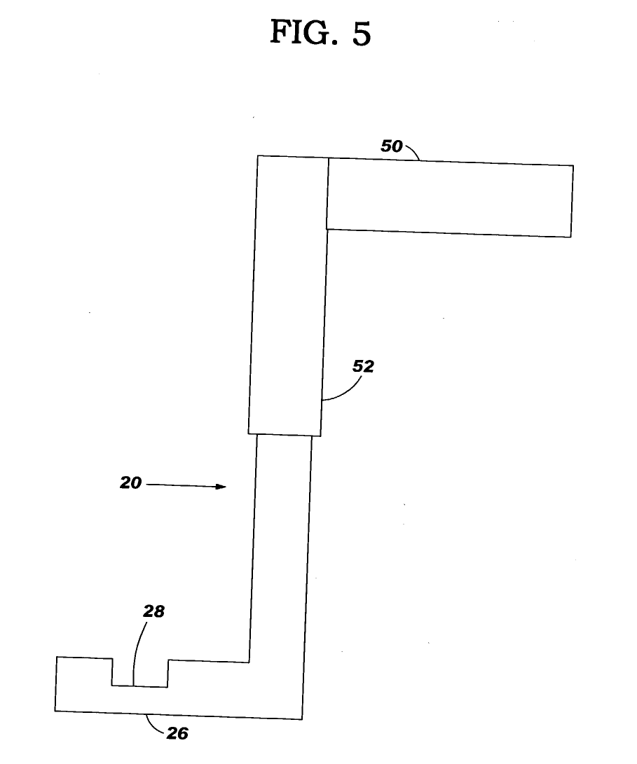

Referring to FIG. 5, is it shown that tool 20 can include a rotatable handle 50 and/or an adjustable elongate portion 52. Rotatable handle 50 would be provided in lieu of the fixed handle 22 and rotatable grip 30 of FIGS. 2 and 4 and can be used to rotate tool 20 within the water for testing purposes (e.g., in a manner similar to rotatable grip 30). Adjustable elongate portion 52 allows the length of tool 20 to be easily changed. As indicated above, elongate portion 52 can require varying lengths depending on the user (e.g., the user's height). Having an adjustable elongate portion 52 allows the length to be easily changed. In a typical embodiment, elongate portion 52 is telescopically adjustable to provide a variety of different lengths. It should be understood that although not depicted, tool 20 of FIG. 5 can include testing tool 32 of FIG. 2 and/or one or more apertures 46 of FIG. 4.

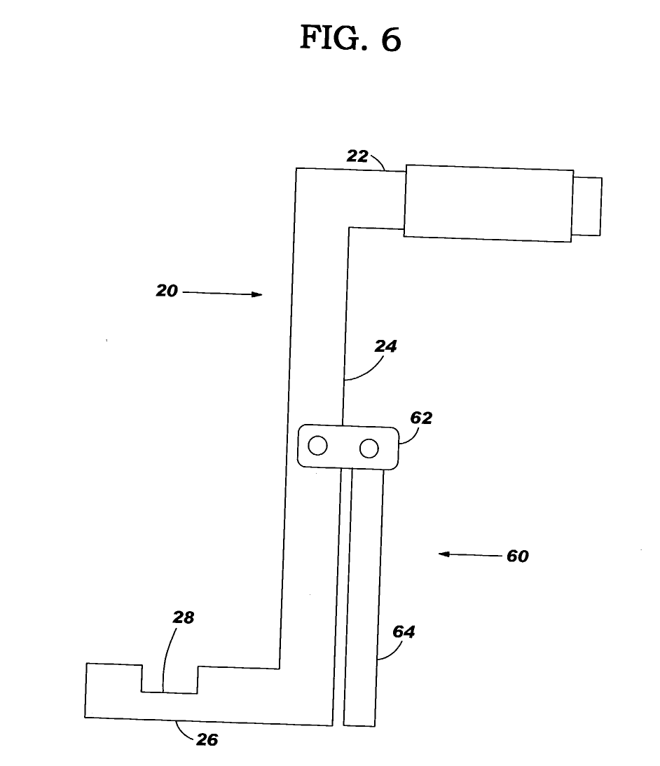

Referring now to FIG. 6, it can be seen that tool 20 could also include support member 60, pivotally extending from elongate portion 24. As shown, a first end 62 of support member 60 extends from elongate portion 24. Second end 64 of support member 60 is coplanar with elongate portion 24 when in a resting position (as shown). When in an extended position, second end 64 of support member 60 is coplanar with engagement portion 26 and handle 22. Support member 60 can be used to support and provide greater leverage when removing cover 10. Specifically, second end 64 would be placed at a position in between the resting position shown and the extended position so that second end 64 contacts the surface (e.g., the concrete) next to cover 10 and skimmer 40. Once such contact is made, handle 22 can be pitched to cause cover 10 to “pop” upwards from skimmer 40. Support member 60 can be used when cover 10 is severely stuck within skimmer 40 such that ordinary upwards lifting of tool 20 cannot free cover 10. Similar to tool 20 of FIG. 5, it should be understood that tool 20 of FIG. 6 could include any of the features shown in FIGS. 2, 4 and 5.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A tool for handling a cover, the tool comprising:
a handle;
an elongate portion extending from the handle; and
an engagement portion extending from the elongate portion, wherein the engagement portion includes a notch for engaging the cover.

2. The tool of claim 1, wherein the handle extends from a first end of the elongate portion, and the engagement portion extends from a second opposing end of the elongate portion.

3. The tool of claim 1, wherein the engagement portion forms an approximately ninety degree angle with the elongate portion, and wherein the handle forms an approximately ninety degree angle with the elongate portion.

4. The tool of claim 1, wherein the notch engages a lip that is adjacent a opening in the cover

5. The tool of claim 1, further comprising a grip rotatably attached to the handle.

6. The tool of claim 1, wherein the handle is rotatable.

7. The tool of claim 1, further comprising a testing tool extending from the engagement portion for determining a status of a liquid.

8. The tool of claim 7, wherein the status comprises at least one of: a temperature, a pH level, and a chemical level.

9. The tool of claim 1, further comprising a support member, pivotally extending from the elongate portion.

10. The tool of claim 9, wherein a first end of the support member extends from the elongate portion, and a second end of the support member is coplanar with the engagement portion when in an extended position.

11. The tool of claim 1, further comprising an aperture on at least one of the engagement portion and the elongate portion for attaching a testing tool.

12. A tool for handling a cover, the tool comprising:
a handle;
a grip rotatably attached to the handle;
an elongate portion extending from the handle at a first end of the elongate portion; and
a engagement portion extending from the elongate portion at an opposing second end of the elongate portion.

13. The tool of claim 12, further comprising a support member, pivotally extending from the elongate portion.

14. The tool of claim 12, further comprising a testing tool extending from the engagement portion for determining a status of a liquid.

15. The tool of claim 12, wherein the handle and the engagement portion form opposing angles of about ninety degrees with the elongate portion.

16. The tool of claim 12, wherein the engagement portion includes a notch for engaging the cover.

17. The tool of claim 12, further comprising an aperture on at least one of the engagement portion and the elongate portion.

18. A tool for handling a cover, the tool comprising:
a handle;
a grip rotatably attached to the handle;
an elongate portion extending from the handle at a first end of the elongate portion;
a engagement portion extending from the elongate portion at an opposing second end of the elongate portion, wherein the engagement portion includes a notch for engaging the cover; and
an aperture on at least one of the engagement portion and the elongate portion for temporarily attaching a testing tool.

19. The tool of claim 18, further comprising a support member, pivotally extending from the elongate portion, wherein a first end of the support member extends from the elongate portion, and a second end of the support member is coplanar with the engagement portion when in an extended position.

20. The tool of claim 18, wherein the length of the elongate portion is adjustable.
